(19) United States
(12) Patent Application Publication
(10) Pub. No.: US 2009/0186985 A1
(43) Pub. Date: Jul. 23, 2009

(54) Functionalized elastomer compositions

(76) Inventors: Roger L. Kuhlman, Lake Jackson, TX (US); Timothy T. Wenzel, Midland, MI (US); Yunwa W. Cheung, Lake Jackson, TX (US); Phillip D. Hustad, Manvel, TX (US); Edmund M. Carnahan, Fresno, TX (US); John R. Briggs, Midland, MI (US); Brian A. Jazdzewski, Midland, MI (US); Wenbin Liang, Sugar Land, TX (US); Roji Mori, Chiba (JP); Kouichi Kizu, Chiba (JP); Nobuo Kawahara, Chiba (JP); Shingo Matuso, Chiba (JP); Shinichi Kojoh, Chiba (JP); Norio Kashiwa, Tokyo (JP)

Correspondence Address: The Dow Chemical Company, Intellectual Property Section, P.O. Box 1967, Midland, MI, 48641-1967, US

(21) Appl. No.: 10/585,597

(22) PCT Filed: Jan. 21, 2005
(86) PCT No.: PCT/US05/02077

§ 371 Date: Jul. 11, 2006

Related U.S. Application Data
(60) Provisional application No. 60/538,355, filed on Jan. 22, 2004.
(60) Provisional application No. 60/609,291, filed on Sep. 13, 2004.

(51) Int. Cl. C08L 53/00

(52) U.S. Cl. 525/88

(57) ABSTRACT

The present invention relates to olefinic compositions comprising a functionalized branched olefin copolymer containing functionalized sidechains derived from olefin and at least one chain end nucleophilic heteroatom containing functional group with at least one protic hydrogen, optionally with one or more copolymerizable monomers, the copolymer characterized by having A) a T_{g}<−10° C. as measured by DSC; B) a Tₐ>100° C.; C) an elongation at break of greater than or equal to 500 percent; D) a Tensile Strength of greater than or equal to 1,500 psi (10,300 kPa) at 25° C.; E) a TMA temperature>80° C., and F) an elastic recovery of greater than or equal to 50 percent.

The invention relates to functionalized elastomer compositions comprised of olefin copolymers having chain end functionalized crystallizable or high T_{g} polyolefin sidechains grafted onto low crystallinity polyethylene backbones.

Triblock and multi-block copolymers are well-known in the art relating to elastomeric polymers useful as thermoplastic elastomer (“TPE”) compositions due to the presence of “soft” (elastomeric) blocks connecting “hard” (crystallizable or glassy) blocks. The hard blocks bind the polymer network together at typical use temperatures. However, when heated above the melt temperature or glass transition temperature of the hard block, the polymer flows readily exhibiting thermoplastic behavior. See, for example, G. Holden and N. R. Legge, Thermoplastic Elastomers: A Comprehensive Review, Oxford University Press (1987).

The best commercially known class of TPE polymers are the styrenic block copolymers (SBC), typically linear triblock polymers such as styrene-isoprene-styrene and styrene-butadiene-styrene, the latter of which when hydrogenated become essentially styrene-(ethylene-butene)-styrene block copolymers. Radial and star branched SBC copolymers are also well-known. These copolymers typically are prepared by sequential anionic polymerization or by chemical coupling of linear diblock copolymers. The glass transition temperature (T_{g}) of the typical SBC TPE is equal to or less than 80-90° C., thus presenting a limitation on the utility of these copolymers under higher temperature use conditions. See, “Structures and Properties of Block Polymers and Multiphase Polymer Systems: An Overview of Present Status and Future Potential”, S. L. Aggarwal, Sixth Biennial Manchester Polymer Symposium (UMIST Manchester, March 1976).

Insertion, or coordination, polymerization of olefins can provide economically more efficient means of providing copolymer products, both because of process efficiencies and feedstock cost differences. Thus useful TPE polymers from olefmically unsaturated monomers, such as ethylene and C₃-C₈ alpha-olefins, have been developed and are also well-known. Examples include the physical blends of thermoplastic olefins (“TPO”) such as polypropylene with ethylene-propylene copolymers, and similar blends wherein the ethylene-propylene, or ethylene-propylene-diolefin phase is dynamically vulcanized so as to maintain well dispersed, discrete soft phase particles in a polypropylene matrix. See, N. R. Legge, “Thermoplastic elastomer categories: a comparison of physical properties”, ELASTOMERICS, pages 14-20 (September, 1991), and references cited therein.

U.S. Pat. No. 4,999,403 discloses graft copolymer compositions comprising a functionalized ethylene-alpha-olefin copolymer having polypropylene grafted thereto through one or more functional linkages. The disclosed process for preparing the graft copolymer compositions comprised combining functionalized ethylene-alpha-olefin copolymer with maleated polypropylene under conditions sufficient to permit grafting of at least a minor portion of the functionalized polymer with the polypropylene. It is well known in the art that the introduction of maleic acid functionality into a polymer through radical grafting results in a distribution of functionalities along the polymer backbone. The reaction of the resulting modified polypropylene with a functionalized elastomer will therefore result in irregular branching, potential for cross linking, and therefore inconsistent and/or undesirable properties.

It is desirable to prepare graft copolymer compositions with a controlled branching architecture, no cross linking, for example, gel weight fraction less than 10 percent, preferably less than 5 percent, more preferably less than 3 percent, and most preferably less than 1 percent, measured in accordance with ASTM method ASTM D2765, and predictable and controllable properties.

It is desirable to prepare graft copolymer compositions with a controlled branching architecture, no cross linking, for example, gel weight fraction less than 10 percent, preferably less than 5 percent, more preferably less than 3 percent, and most preferably less than 1 percent, measured in accordance with ASTM method D2765 and predictable and controllable properties.

The present invention relates to olefinic compositions comprising a functionalized branched olefin copolymer containing functionalized sidechains derived from olefin and at least one chain end nucleophilic heteroatom containing functional group with at least one protic hydrogen, optionally with one or more copolymerizable monomers, the copolymer characterized by having A) a T_{g}<−10° C. as measured by DSC; B) a Tₘ>100° C.; C) an elongation at break of greater than or equal to 500 percent; D) a Tensile Strength of greater than or equal to 1,500 psi (10,300 kPa) at 25° C.; E) a TMA temperature>80° C., and F) an elastic recovery of greater than or equal to 50 percent.

As used herein, “functionalized branched olefin copolymers” refer to olefin polymers that have been modified to introduce elements other than carbon and hydrogen. Preferably at least about 30 percent of the polymer molecules have been modified. The functional group can be selected from the group consisting of primary or secondary amines, alcohols, thiols, aldehydes, carboxylic acids and sulfonic acids. Preferably, the amines correspond to the formula P—N—R_{X}H_{M}, wherein P is the polymer side chain derived from olefin, N is nitrogen, R is C1-C20 hydrobarbyl, H is hydrogen, M is 1 or 2 and X is (2−m). Suitable examples of “functionalized olefin copolymers” include maleic anhydride graft modified polyolefins (for example, polyethylene or polypropylene), and amine terminated polyolefins.

Preferably, the functionalized sidechains in the olefinic composition have a T_{g} of less than −30° C. and the Tₘ of the sidechains is greater than or equal to 100° C.

Also preferred are thermoplastic elastomer compositions wherein said functionalized branched olefin copolymer comprises functionalized sidechains derived from propylene and at least one chain end primary amine functional group, optionally with one or more copolymerizable monomers.

The functionalized branched olefin copolymer preferably can comprise functionalized sidechains derived from 4-methyl-1-pentene and at least one chain end primary amine functional group, optionally with one or more copolymerizable monomers.

In other embodiments, we have also discovered a process of making a functionalized branched olefin copolymer comprising reacting a maleated elastomer with an amine terminated olefin polymer, and a process of making a functionalized branched olefin copolymer comprising reacting a maleated elastomer with an olefinic polymer containing a chain end nucleophilic heteroatom containing functional group with at least protic hydrogen. Preferably, the reacting step is performed in an extruder, more preferably the reacting step is performed in solution.

The functionalized branched olefin copolymer in the compositions can comprise a functionalized ethylene/alpha-olefin copolymer having a density of less than about 0.89 g/cc, preferably wherein the functionality is capable of reacting with a primary amine, especially a functionalized propylene/alpha-olefin copolymer having a density of less than about 0.87 g/cc, wherein the functionality is capable of reacting with a primary amine.

Preferably, the functionalized copolymer is formed from components comprising an unsaturated organic compound containing at least one olefinic unsaturation and at least one carboxyl group or at least one derivative of the carboxyl group selected from the group consisting of an ester, an anhydride and a salt. Preferably, the unsaturated organic compound is selected from the group consisting of maleic, acrylic, methacrylic, itaconic, crotonic, alpha-methyl crotonic and cinnamic acids, anhydrides, esters and their metal salts and fumaric acid and its ester and its metal salt. Maleic anhydride is most preferred.

In yet another embodiment of the invention, a thermoplastic elastomer composition derived from at least two functionalized olefin copolymers has been discovered, each copolymer derived from olefins capable of insertion polymerization and each copolymer having a Tₘ difference of at least 40° C., the composition having; A) a T_{g}<−10° C. as measured by DSC; B) a Tₘ>100° C.; C) an elongation at break of greater than or equal to 500 percent; D) a Tensile Strength of greater than or equal to 1,500 psi (10,300 kPa) at 25° C.; E) a TMA temperature>80° C., and F) an elastic recovery of greater than or equal to 50 percent, wherein at least one functionalized copolymer is chain end functionalized with at least one chain end nucleophic heteroatom containing functional group with at least one protic hydrogen, especially wherein the two functionalized olefin copolymers are selected from the group consisting of maleated elastomer and amine terminated olefin polymers, further, wherein one of the functionalized olefin copolymers is selected from the group consisting of maleated elastomers, and one functionalized olefin copolymer is selected from amine terminated (primary or secondary) olefin polymers. Preferably, the composition has an additional T_{g} of greater than about 80° C.

In still another embodiment, a thermoplastic elastomer composition derived from at least two functionalized olefin copolymers is discovered, each copolymer derived from olefins capable of insertion polymerization and each copolymer having a T_{g} difference of at least 100° C., the composition having A) a T_{g}<−10° C. as measured by DSC; B) an elongation at break of greater than or equal to 500 percent; C) a Tensile Strength of greater than or equal to 1,500 psi (10,300 kPa) at 25° C.; D) a TMA temperature>80° C., and E) an elastic recovery of greater than or equal to 50 percent, wherein at least one functionalized copolymer is chain end functionalized with at least one chain end nucleophilic heteroatom containing functional group with at least one protic hydrogen, preferably wherein the two functionalized olefin copolymers are selected from the group consisting of maleated elastomer and amine terminated olefin polymers, further, wherein one of the functionalized olefin copolymers is selected from the group consisting of maleated elastomers, and one functionalized olefin copolymer is selected from amine terminated olefin polymers. Preferably, the composition has an additional T_{g} of greater than about 80° C.

In yet another embodiment, an olefin composition is discovered which comprises a functionalized branched olefin copolymer containing functionalized sidechains derived from ethylene and at least one chain end nucleophilic heteroatom containing functional group with at least one protic hydrogen, optionally with one or more copolymerizable monomers, the copolymer having A) at least one T_{g}<−10° C. as measured by DSC, B) an elongation at break of greater than or equal to 500 percent; C) a Tensile Strength of greater than or equal to 1,500, psi (10,300 kPa) at 25° C.; D) a TMA temperature>80° C., and E) an elastic recovery of greater than or equal to 50 percent. Preferably, the composition has an additional T_{g} of greater than about 80° C.

In still another embodiment, an olefin composition is discovered which comprises a functionalized branched olefin copolymer containing functionalized sidechains derived from propylene and at least one chain end nucleophilic heteroatom containing functional group with at least one protic hydrogen, optionally with one or more copolymerizable monomers, the copolymer having A) at least one T_{g}<−10° C. as measured by DSC, B) an elongation at break of greater than or equal to 500 percent; C) a Tensile Strength of greater than or equal to 1,500, psi (10,300 kPa) at 25° C.; D) a TMA temperature>80° C., and E) an elastic recovery of greater than or equal to 50 percent.

In another embodiment, an olefin composition is discovered comprising a functionalized branched olefin copolymer containing functionalized sidechains derived from 4-methyl-1-pentene and at least one chain end nucleophilic heteroatom containing functional group with at least one protic hydrogen, optionally with one or more copolymerizable monomers, the copolymer having A) at least one T_{g}<−10° C. as measured by DSC, B) an elongation at break of greater than or equal to 500 percent; C) a Tensile Strength of greater than or equal to 1,500, psi (10,300 kPa) at 25° C.; D) a TMA temperature>80° C., and E) an elastic recovery of greater than or equal to 50 percent.

The thermoplastic elastomer compositions, and blends thereof, of this invention are comprised of branched copolymers wherein both the copolymer backbone and polymeric sidechains are derived from monoolefins polymerized under coordination or insertion conditions with activated transition metal organometallic catalyst compounds. The sidechains are copolymerized so as to exhibit crystalline, semi-crystalline, or glassy properties suitable for hard phase domains in accordance with the art understood meaning of those terms, and are grafted to a polymeric backbone that is less crystalline or glassy than the sidechains, preferably, substantially amorphous, so as to be suitable for the complementary soft phase domains characteristic of thermoplastic elastomer compositions.

The sidechains are comprised of chemical units capable of forming crystalline or glassy polymeric segments preferably under conditions of insertion polymerization. Known monomers meeting this criteria are ethylene, propylene, 4-methyl-1-pentene, and copolymers thereof, including ethylene copolymers with alpha.-olefin, cyclic olefin or styrenic comonomers. Ethylene or propylene copolymer sidechains are preferable provided that the amount of comonomer is insufficient to disrupt the crystallinity. Suitable comonomers include C₃-C₂₀ alpha-olefins or geminally disubstituted monomers, C₅-C₂₅ cyclic olefins, styrenic olefins and lower carbon number (C₃-C₈) alkyl-substituted analogs of the cyclic and styrenic olefins. Preferably, the sidechains can comprise from 90-100 mol percent propylene, and from 0-10 mol percent comonomer, preferably 92-99 mol percent propylene and 1-8 mol percent comonomer, most preferably 95-98 mol percent propylene and 2-5 mol percent comonomer. The selection of comonomer can be based upon properties other than crystallinity disrupting capability, for instance, a longer olefin comonomer, such as 1-octene, may be preferred over a shorter olefin such as 1-butene for improved polyethylene film tear. For improved polyethylene film elasticity or barrier properties, a cyclic comonomer such as norbornene or alkyl-substituted norbornene may be preferred over an alpha-olefin.

The Mₙ of the sidechains are within the range of from greater than or equal to 1,500 and less than or equal to 75,000. Preferably the Mₙ of the sidechains is from 1,500 to 50,000, and more preferably the Mₙ is from 1,500 to 25,000. The number of sidechains is related to the Mₙ of the sidechains such that the total weight ratio of the weight of the sidechains to the total weight of the polymeric backbone segments between and outside the incorporated sidechains is less than 60 percent, preferably 10-40 percent, most preferably from 10-25 percent. Molecular weight here is determined by gel permeation chromatography (GPC) and differential refractive index (DRI) measurements.

The molecular weight distributions of polyolefin, particularly ethylene, polymers are determined by gel permeation chromatography (GPC) on a Waters 150° C. high temperature chromatographic unit equipped with a differential refractometer and three columns of mixed porosity. The columns are supplied by Polymer Laboratories and are commonly packed with pore sizes of 10³, 10⁴, 10⁵ and 10⁶ Å. The solvent is 1,2,4-trichlorobenzene, from which about 0.3 percent by weight solutions of the samples are prepared for injection. The flow rate is about 1.0 milliliters/minute, unit operating temperature is about 140° C. and the injection size is about 100 microliters.

The molecular weight determination with respect to the polymer backbone is deduced by using narrow molecular weight distribution polystyrene standards (from Polymer Laboratories) in conjunction with their elution volumes. The equivalent polyethylene molecular weights are determined by using appropriate Mark-Houwink coefficients for polyethylene and polystyrene (as described by Williams and Ward in Journal of Polymer Science, Polymer Letters, Vol. 6, p. 621, 1968).

M_{polycthylene}=a*(M_{polystyrene})^{b}.

In this equation, a=0.4316 and b=1.0. Weight average molecular weight, Mw, is calculated in the usual manner according to the following formula: Mⱼ=(Σwᵢ(Mᵢ^{j}))^{j}. Where wᵢ is the weight fraction of the molecules with molecular weight Mᵢ eluting from the GPC column in fraction i and j=1 when calculating M_{w} and j=−1 when calculating Mₙ.

The backbone, or backbone polymeric segments, when taken together with the sidechain interruption of the backbone structure, should have a lower Tₘ (or T_{g} if not exhibiting a Tₘ) than the sidechains. Thus it will preferably comprise segments of chemical units not having a measurable crystallinity, or having a T_{g} lower than −10° C. The backbone segments as taken together typically will have a Tₘ less than or equal to 80° C. and a T_{g} less than or equal to −10° C. Elastomeric backbones will be particularly suitable, such will typically be comprised of ethylene and one or more of C₃-C₁₂ alpha-olefins or diolefins, particularly propylene, 1-butene, and 1-octene. Other copolymerizable monomers include generally disubstituted olefins such as 4-methyl-1-pentene, hexene, isobutylene, cyclic olefins such as cyclopentene, norbornene and alkyl-substituted norbornenes, and styrenic monomers such as styrene and alkyl substituted styrenes. Low crystallinity backbones are suitable, examples are high comonomer content ethylene copolymers (as described before), for example, greater than 8 mol percent comonomer.

As indicated above the mass of the backbone will typically comprise at least 40 wt percent of the total polymer mass (that is that of the backbone and the sidechains together) so the backbone typically will have a weight-average molecular weight (M_{w}) of at least equal to or greater than about 50,000.

In one embodiment, the molecular weights and relative amounts of the hard segments and the elastomer chains of the backbone are controlled such that more than about 40 percent, more preferably more than 50 percent of the elastomer chains of the backbone in the final graft copolymer composition have, on average, at least two sidechains, alternatively at least 3 side chains, but less than 5 sidechains, and preferably less than 4 sidechains per elastomer chain.

The branched olefin copolymers comprising the above sidechains and backbones will typically have an M_{w} equal to or greater than 50,000 as measured by GPC/DRI as defined for the examples. The M_{w} typically is less than 300,000, preferably less than 250,000.

The thermoplastic elastomer composition of the invention can be prepared by a process comprising reacting a maleated elastomer with an amine terminated olefin polymer. The grafting process can be carried out in a homogeneous solution, a melt blend of the two component polymers, or in an extruder. The melt blending process is commonly performed using a twin-rotor mixer, preferably a twin-screw extruder having modular mixing sections, of sufficient length such as to achieve adequate mixing. Solution grafting, i.e. heating both components in a common solvent such as hydrocarbons, chlorinated and unchlorinated aromatics, at a temperature suitable to dissolve both materials and mixing until the desired grafting level is achieved. The polymer is recovered by removing the solvent. Preferably, a solvent is chosen such that the grafted copolymer precipitates from solution on cooling below 30° C., and the polymer can be recovered by filtration. Suitable solvents include hydrocarbon mixtures such as Isopar™E sold by Exxon Chemical. Percentage of the polypropylene which is grafted can vary from low levels such as 30 percent by weight of total polypropylene, but preferably is greater than 50 percent, most preferably greater than 65 percent, but can be as high as 100 percent. Grafting level can be determined by GPC methods.

Suitable maleation techniques include those described in U.S. Pat. No. 5,346,963 (Hughes et al.), U.S. Pat. No. 5,705,565 (Hughes et al.), U.S. Pat. No. 4,762,890 (Strait et al.), USP 4,927,888 (Strait et al.), U.S. Pat. No. 5,045,401 (Tabor et al.), and U.S. Pat. No. 5,066,542 (Tabor et al.).,

Throughout the description above, and below, the phrase “chain-end” or “terminal” when referring to functionality means a functional group within 10 monomer units from the end of the polymer chain.

In one embodiment, propylene with chain end unsaturation, suitable as branches for a subsequent grafting reaction, can be prepared under solution polymerization conditions with metallocene catalysts suitable for preparing either of isotactic or syndiotactic polypropylene. These polymers may be converted to primary amine-terminated reagents by one of several methods. These methods include, inter alia, hydroformylation followed by conversion of the aldehyde or ketone to a primary amine and hydroformylation in the presence of a secondary amine followed by conversion of the resulting tertiary amine to a primary amine. Levels of amination can vary depending on desired product properties, but is typically greater than 50 percent (mole percent based on 1H NMR of chain ends), more preferably greater than 70 percent, and can be as high as 100 percent.

Generally, for isotactic polypropylene, the stereorigid transition metal catalyst compound is selected from the group consisting of bridged bis(indenyl) zirconocenes or hafnocenes. In a preferred embodiment, the transition metal catalyst compound is a dimethylsilyl-bridged bis(indenyl) zirconocene or hafnocene. More preferably, the transition metal catalyst compound is selected from a series of pyridyl amine catalysts as disclosed in WO 2002/038628, U.S. Pat. No. 6,320,005 and U.S. Pat. No. 6,103,657

The polypropylene sidechains are preferably prepared in solution at a temperature from 110° C. to 130° C. More preferably, a temperature from 110IC to 125° C. is used. The pressures of the reaction generally can vary from atmospheric to 345 MPa, preferably to 182 MPa. The reactions can be run batchwise or continuously. Conditions for suitable slurry-type reactions will also be suitable and are similar to solution conditions, except the reactions are typically carried out at lower temperatures. The polymerization is typically run in liquid propylene under pressures suitable to such.

Additionally the sidechains are prepared under suitable conditions such that greater than 50 percent of the chain end groups are unsaturated, preferably greater than 65 percent, most preferably greater than 80 percent, but can be as high as 100 percent (mole percent determined by 1H NMR of end groups). Unsaturated end groups can include vinyl, vinylidene, vinylene, or mixtures thereof.

The thermoplastic elastomer compositions according to the invention will have use in a variety of applications wherein other thermoplastic elastomer compositions have found use. Such uses include, but are not limited to, those known for the styrene block copolymers, for example, styrene-isoprene-styrene and styrene-butadiene-styrene copolymers, and their hydrogenated analogs. Such applications include a variety of uses such as backbone polymers in adhesive compositions and molded articles. These applications will benefit from the increased use temperature range, typically exceeding the 80-90° C. limitation of the SBC copolymer compositions. The compositions of the invention will also be suitable as compatibilizer and impact modifier compounds for polyolefin blends. Additionally, due to the relatively high tensile strength, elasticity, and ease of melt processing, extruded film, coating and packaging compositions can be prepared comprising the invention thermoplastic elastomer compositions, optionally as modified with conventional additives and adjuvents. Further, in view of the preferred process of preparation using insertion polymerization of readily available olefins, the invention thermoplastic elastomer compositions can be prepared with low cost petrochemical feedstock under low energy input conditions (as compared to either of low temperature anionic polymerization or multistep melt processing conditions where vulcanization is needed to achieve discrete thermoplastic elastomer morphologies).

### EXAMPLES

The following examples are given to illustrate various embodiments of the invention. They do not intend to limit the invention as otherwise described and claimed herein. All numerical values are approximate. When a numerical range is given, it should be understood that embodiments outside the range are still within the scope of the invention unless otherwise indicated. In the following examples, various polymers are characterized by a number of methods. Performance data of these polymers are also obtained. Most of the methods or tests are performed in accordance with an ASTM standard, if applicable, or known procedures.

Isopar™E hydrocarbon mixture is obtained from Exxon Chemicals. Rac-[Dimethylsilane-diylbis(1-(2-methyl-4-phenyl)indenyl)]zirconium (trans,trans-1,4-Diphenyl-1,3-butadiene) is prepared according to U.S. Pat. No. 6,465,384, especially example 15 Bis(hydrogenated-tallowalkyl)methylammonium tetrakis(pentafluorophenyl)borate is prepared according to U.S. Pat. 5,919,983. PMAO-IP is obtained as a toluene solution from Akzo Chemicals and is used without further purification.

Unless indicated otherwise, the following testing procedures are to be employed:
A. Tensile Testing At Room Conditions. Tensile testing is done using ASTM D-1708 with microtensile bars cut to the sample specifications. The cross-head speed is set to 127 mm/min. (5 inches/min.). Testing environment is not to ASTM standards for temperature and humidity. Samples are tested as is and are not conditioned according to ASTM D-1708.
B. Procedure for Tensile Hysteresis Tensile hysteresis is measured using the geometry outlined in ASTM D1708. The gauge length is 22.25 mm long by 4.8 mm wide. The loading and unloading strain rate is 500 percent/mm. The test procedure is carried out as follows: The sample is loaded with Mylar in grips and the load is zeroed. The sample is then pulled to 100 percent strain. The sample is retracted to 0 percent strain and reloaded to positive load. Permanent set is the strain at which the load becomes zero upon reloading. The elastic recovery is defined as 100 percent minus the permanent set.
C. Differential Scanning Calorimetry (DSC) measurements are performed on a TA Instruments Q1000. Heat the sample in DSC to 30° C. (at approximately 100° C./min) above the melting point. Keep isothermal for 3 minutes to ensure complete melting. Cool the sample at 10° C./min to −40° C. Keep the sample isothermal for three minutes to stabilize. Melting (from second heat) and crystallization temperatures are recorded from the peak temperatures of the endotherm and exotherm, respectively. Glass transition temperature is taken as the temperature at the inflection point of the change in heat capacity.
D. TMA. A Perkin Elmer TMA 7 (Thermomechanical Analyzer) is loaded with samples with a thickness of 2 to 4 mm. A flat-headed needle with a load of one Newton is placed against the sample at room temperature. The temperature is ramped at 5° C./min from 25° C. to 190° C. The test is stopped before 190° C. if the needle has penetrated I mm into the sample. The TMA temperature is defined as the temperature at which the sample penetration reaches 1 mm.

### Example 1

### Polypropylene Macromer Synthesis Via Thermal Termination

A stirred, one gallon (3.79 L) autoclave reactor is charged with 1400 g Isopar™E hydrocarbon solvent and 580 g propylene. The reactor is heated to the desired temperature (110° C.-125° C.). The catalyst system is prepared in a drybox by combining together rac-[Dimethylsilane-diylbis( 1 -(2-methyl4-phenyl)indenyl)]zirconium (trans,trans-1,4-Diphenyl-1,3-butadiene), bis(hydrogenated-tallowalkyl)methylammonium tetrakis(pentafluorophenyl)borate, and AKZO PMAO-IP in a 1:1.1:38 molar ratio, with additional solvent to give a total volume of 17 ml. The activated catalyst is injected into the reactor. The reactor temperature is maintained constant by cooling the reactor as required. After 10 minutes the hot solution is transferred into a nitrogen purged resin kettle. An additive solution containing a phosphorus stabilizer and phenolic antioxidant (Irgaphos 168 and Irganox 1010 (both from Ciba Geigy) in toluene in a 2:1 weight ratio) is added to provide a total additive concentration of about 0.1 wt percent in the polymer. The polymer is dried in a vacuum oven at 70° C. over night.

### Example 2

### Pyrolysis of Polypropylene

8 kg of polypropylene ([η]=1.6 dg/L) is thermally degraded in a nitrogen-sealed single screw extruder (20 mmn, residence time: 10 min) at 410° C. to obtain terminally unsaturated polypropylene (PP-A). GPC and 1H-NMR analyses indicates that weight-average molecular weight (Mw) of PP-A is 10,400 and the content of vinylidene group in it is 4.77 units per 1,000 carbons.

### Example 3

### Hydroxylation Of Polypropylene Macromers From Pyrolysis Route

Into a nitrogen-sealed glass reactor, 100 g of PP-A prepared according to Example 2 and 750 mL of n-decane are added. It is heated to 130° C. with stirring at 600 rpm and 170 mrol of diisobutyl aluminum hydride is added into it at that temperature. The mixture is kept at that temperature for 6 hours with stirring. Then, dried air is fed into it at a rate of 100 L/h at that temperature for 6 hours with keeping the stirring. Next, it is cooled to 80° C., followed by addition of 50 mL of methylacetoacetate and 50 mL of isobutylalcohol. It is stirred at that temperature for 2 hours and poured into mixture of acetone (1.5 L) and methanol (I .5L) then stirred with a stirrer bar, followed by filtration and washing with plenty of acetone and methanol. Thus obtained polymer (PP-OH) is vacuum-dried at 80° C. for 10 hours. DSC and 1H NMR analyses indicates that melting temperature of PP-OH was 151° C. and content of hydroxyl group in it is 1.71 units per 1,000 carbons.

### Example 4

### Preparation And Properties of the Functionalized Branched Olefin Copolymer

Into a nitrogen-sealed glass reactor, 18 g of PP-OH prepared according to Example 3 and 42 g of ethylene/butene random copolymer grafted by maleic anhydride (EBR-g-MAH; T_{g}: −64° C.; content of ethylene: 80 mol percent; content of maleic anhydride: 1.0 wt percent; Mw: 250,000) are added with 1.5 L of n-decane. It is heated to 135° C. with stirring at 600 rpm and 0.05 g of p-toluenesulfonic acid is added into it at that temperature then kept at that temperature with stirring for 6 hours. Then, it is cooled gradually and poured into mixture of acetone (1.5 L) and methanol (1.5 L) and stirred with a stirrer bar, followed by filtration and washing with plenty of acetone and methanol. Thus obtained functionalized branched olefin copolymer is vacuum-dried at 80° C. for 10 hours.

Properties of the functionalized branched olefin copolymer:

Tensile Strength: 16,100 kPa; Elongation at Break: 845 percent; Elastic Recovery: 63.1 percent; TMA: 150.1° C.

### Example 5

Functionalization of Polypropylene with 2-Hydroxymethylmethacrylate

Polypropylene ([η]=10.5 dg/L), 2-hydroxyrnethylmethacrylate(HEMA) and t-butylperoxybenzoate are blended at a ratio of 100:6:3 with a Henschel mixer. Then, it is extruded to pellets with a twin screw extruder (Technobell ZSK-30) at 210° C. to obtain HEMA-grafted polypropylene (PP-g-HEMA). The resulting [η] is 0.76 dg/L, content of HEMA is 4.0 wt percent and melting temperature is 157° C.

### Example 6

### Preparation and Properties of the Functionalized Branched Olefin Copolymer

105 g of PP-g-HEMA prepared according to Example 5 and 245 g of EBR-g-MAH which was used in Example 3 are extruded to pellets at 200° C. with a 20 mmφ twin screw extruder. The screw rotation is 100 rpm and the blending time is 1 min to obtain the functionalized branched olefin copolymer.

Properties of the functionalized branched olefin copolymer:

Tensile Strength: 19,300 kPa; Elongation at Break: 886 percent; Elastic Recovery: 78.9 percent; TMA: 159.5° C.

### Example 7

Preparation of Amine Terminated polypropylene
A] Hydroformylation of Olefin-Terminated Polypropylene. A one-gallon Parr reactor is charged with olefin-terminated polypropylene prepared according to Example 1 (244 g), and toluene (1472 g, 1702 mL). The reactor is purged with 1:1 syn gas and then vented. Via cannula transfer, 128 g of a catalyst solution is charged. The catalyst solution consisted of dry, deoxygenated THF (165 g, 186 mL), Rh(CO)2(acac) (2.47 g, 9.57 mmol), and tris(2,4-di-t-butylphenyl)phosphite (30.12 g, 46.6 mmol) (L/Rh=4.87; 4997 ppm Rh). The reactor is pressurized to 200 psi with 1:1 syn gas and heated to 80° C., then pressurized to 300 psi and heated to 100° C. After 4 hours, the-reactor is vented, dumped hot and washed with hot toluene. The polymer is precipitated by pouring into methanol, and then washed with additional methanol, and dried in vacuo. 232 g (95 percent) of white powder are recovered. 1H NMR resonances between δ9.6-9.9 are assigned to aldehyde hydrogens.
B] In a nitrogen atmosphere, a three-liter flask is charged with tetrahydrofuran (1000 mL), formyl-terminated polypropylene (200 g) prepared according to Example 7A, and triethylamine (4.65 mL, 33.3 mmol). A solution of hydroxylammonium chloride (1.72 g, 26.7 mmol) in 200 mL THF is placed in an addition funnel attached to the three-liter flask. The hydroxylamine hydrochloride solution is added dropwise over ˜1 hour to the stirring polymer slurry. At this time, the reaction mixture is stirred and heated to 60° C. for six hours. After cooling to room temperature, the polymer is washed sequentially with water, methanol, and acetone. 1H NMR resonances between δ6.3-6.8 are assigned to oxime hydrogens.
C] Reaction of Oxime-Terminated Polypropylene to Form Amine-Terminated Polypropylene.

In a nitrogen filled glove box, a 2-L flask is charged with 100 g of the oxime-terminated polypropylene prepared according to Example 7B and 800 mL dry THF. To the slurry is added 60 mL of a 1 M solution of LiAlH4 in THF. The solution is heated to reflux for 4 hours. The solids dissolve on heating to form a homogeneous solution, and over the course of the reaction a grey precipitate forms. The polymer is allowed to cool to a gel and is brought out of the box. The polymer/solvent gel is added to 1 L of MeOH with stirring. Some gas evolution is observed as residual LiAlH4 is consumed. The polymer is stirred for 30 minutes, collected on a flitted funnel, washed twice with 500 mL MeOH, and aspirated to a free flowing powder. The powder is dried in a vacuum oven at 50° C. over night.

### Example 8

### Preparation of the Functionalized Branched Olefin Copolymer

Samples of Ethylene-Octene Copolymer grafted with Maleic Anhydride (DuPont Fusabond NMN-4940) are made (EO-g-MAH). The EO copolymer has a pre-grafted density of about 0.87 g/cm³ and a pre-grafted melt index of about 1 g/10 minutes; grafting occurs at a level of about 1 wt percent MAH. The EO-g-MAH polymers are mixed with amine-terminated polypropylene prepared according to Example 7 in a Haake Rheocord 9000 mixer. A total of 140 grams of EO-g-MAH is melted at 170° C. in a Haake R3000 bowl with a sample volume of310 ml at 30 RPM. A total of 60 grams of amine-terminated PP is slowly added and each aliquot is allowed to react to completion. The reaction is monitored via an increase in torque. Once all of the PP is added, the graft copolymer is melt mixed for another five minutes.

### Properties

| | Tensile | Elongation @ | Elastic | |
|---|---|---|---|---|
| | Strength, | Break, | Recovery, | TMA, |
| Sample | psi | percent | percent | ° C. |
| Blend* | 1220 | 720 | 69 | 79 |
| Graft Copolymer** | 2490 | 800 | 78 | 110 |

*Blend: physical blend of EO-g-MAH and iPP
**Graft Copolymer: example of this invention; graft copolymer of EO-g-MAH iPP and NH2-t-iPP

### Example 9

### Preparation of Hydroxyl-Terminated Polypropylene

In a nitrogen filled glove box, a 2-L flask is charged with 100 g of the formyl-terminated polypropylene prepared according to Example 7A and 800 mL dry THF. To the slurry is added 60 mL of a 1 M solution of LiAlH4 in THF. The solution is heated to reflux for 4 hours. The solids dissolve on heating to form a homogeneous solution, and over the course of the reaction a grey precipitate forms. The polymer is allowed to cool to a gel and is brought out of the box. The polymer/solvent gel is added to 1 L of MEOH with stirring. Some gas evolution is observed as residual LiAlH4 is consumed. The polymer is stirred for 30 minutes, collected on a fritted funnel, washed twice with 500 mL MeOH, and aspirated to a free flowing powder. The powder is dried in a vacuum oven at 50° C. over night.

### Example 10

### Grafting of Hydroxyl-Terminated iPP to a Maleated Elastomer

Maleated ethylene-octene copolymer (maleic anhydride grafted ethylene/1-octene copolymer having a pre-grafted melt index of about 1 g/10 minutes and a pre-grafted density of about 0.87 g/cm³, and pre-grafted Mw/Mn of about 2, and a final content of EO-g-MAH about 0.8 wt percent MAH (EO-g-MAH)) is used for grafting with hydroxyl-terminated iPP prepared according to Example 9. Two methods are used for the grafting reaction.
A] Melt Grafting: In the melt-grafting method, a total of 140 grams of EO-g-MAH is melted at 170° C. using a Haake Rheocord 9000 mixer with a sample volume of 310 ml at 30 RPM. A total of 60 grams of hydroxyl-terminated iPP is slowly added to the mixer and the torque of the mixer is monitored and used as an indicator of the grafting reaction. Once all of the hydroxyl-t-iPP is added, the graft copolymer is melt-mixed for another five minutes. The blend is removed from the Haake and cooled to room temperature.
B] Solution Grafting: The grafting reaction is also conducted in solution. Into a dry, 3-neck, 2000 mL round bottom flask is loaded hydroxyl-terminated polypropylene (16.93 g, Mw 55K) and EO-g-MAH (as described in Ex. 10A (39.51 g)). Flask is placed under a slow N2 purge via a glass inlet adaptor and exiting via an outlet adaptor through a mineral oil bubbler. Apparatus is completed with a glass stir-shaft with glass blade, stir-bearing, stir-motor, Dean-Stark trap, condenser, and heating-mantle. Xylene (1145 mL) is added to the flask with heating started. After reaching a gentle reflux, ˜35 mL of distillate is removed from the Dean-Stark trap (distillate remains clear). Mixture remains at a slow reflux for 8 hours. Solution is cooled slightly and product is precipitated into ˜2.5 L of methanol containing Irganox™ 1010 (˜0.5 g) as a soft, opaque solid. Precipitated polymer is collected and soaked in fresh methanol (˜1.5 L) containing Irganox™ 1010 (0.1 g) for ˜15 minutes which is repeated twice more. Polymer is collected and dried overnight to constant weight in a 60° C. vacuum oven under full pump vacuum.

Properties of the melt-grafted olefin copolymer:

Tensile Strength: 7.5 MPa; Elongation at Break: 735 percent; Elastic Recovery: 79 percent; TMA: 108° C.

Properties of the solution-grafted olefin copolymer:

Tensile Strength: 13.1 MPa; Elongation at Break: 980 percent; Elastic Recovery: 76 percent; TMA: 93° C.

### Example 11

### Grafting of Amine-Terminated Poly(4-Methyl-1-Pentene) (P4MP1) to A Maleated Elastomer

In the following example, Syngas refers to a 2:1 mole-to-mole mixture of H₂/CO except where noted otherwise. Solvents (Sure-Seal), amines, 2,4-di-t-butylphenylphosphite, lithium aluminum hydride, and hydroxylamine hydrochloride were obtained from Aldrich and were used as received. [Rh(CO)₂(acac)] was prepared in house according to standard literature procedures.

Synthesis of cyanoethylaminomethylated poly(4methyl-1-pentene). A 1 gal stainless steel autoclave is charged with poly(4-methyl-1 -pentene) (76.04 g, 3.5 mmol olefin functionalization, Mₙ of ˜22000), 1.5 L of toluene and N-methyl-β-alaninenitrile (20 mL, 215.6 mmol). The autoclave is pressure tested, briefly purged with N₂, purged with syngas (2:1 H₂/CO), and the contents stirred under 400 psi syngas (2:1 H₂/CO) for 20 min. The reactor is heated slowly to 60° C., vented and charged with a catalyst solution comprising Rh(CO)₂(acac) (4.42 g, 17.1 mmol) and tris-2,4-di-t-butylphenylphosphite (23.34 g, 36.1 mmol) in 250 mL toluene via a pressurized (80 psi N₂) Whitey cylinder. The reactor is then heated to 80° C., pressurized to 400 psi with syngas (2:1 H₂/CO) and stirred for 14 h. After cooling to 60° C., the reactor is purged with N₂ and dumped. An equal volume of MeOH is added to induce polymer precipitation. The resulting solid is filtered and washed with acetone until the filtrate is colorless (˜2 L). The filter cake is dried in a vacuum oven overnight and a sample can be submitted for ¹H NMR. If analysis of the NMR data reveals incomplete conversion of the starting material, for example, 65-70 percent conversion to desired product, then the isolated polymer mixture (vide infra), 68.75 g, is added to the same stainless steel autoclave with an additional 1.5 L of toluene and N-methyl-β-alaninenitrile (20 mL, 215.6 mmol). After purging and stirring under syngas as described above, the reaction mixture is heated to 60° C. and a catalyst solution comprising Rh(CO)₂(acac) (4.31 g, 16.7 mmol) and tris-2,4-di-t-butylphenylphosphite (22.99 g, 35.5 nmol) in 250 mL THF is added. The reaction mixture is heated to 80° C., pressurized to 400 psi syngas (2:1 H₂/CO) and stirred for an additional 14 h. Isolation of the product as described above yields 63.58 g of colorless powder. A sample can be submitted for ¹H NMR. Analysis of the NMR data should reveal that this material is suitable for reduction with LiAlH₄.

Reduction of cyanoethylaminomethylated poly(4-methyl-1-pentene). To a 3 L flask, cyanoethylaminomethylated poly(4-methyl-1 -pentene) (63.58 g, 2.89 mmol nitrile functionalization) and 1 L dry THF are added. After purging with N₂ for 15 min LiAlH₄ (1.13 g, 29.8 mmol) is slowly added and the slurry is heated to 60° C. for 4 h. After cooling to ambient temperature the reaction is cautiously quenched with water (200 mL total). The polymer is then filtered, suspended in dilute aq. H₂SO₄ (pH 2) for 10 min, filtered and washed with H₂O (1 ). The resulting filter cake is suspended in a 0.1 M NaOH solution (800 mL), filtered, washed with H₂O (1 ), washed with THF to remove residual H₂O and then dried in a vacuum oven at 60° C. for 48 h to yield the desired product as a colorless solid, 60 g. NMR analysis should confirm that the product is the desired amine-terminated poly(4-methyl-1-pentene).

Grafting of amine-terminated poly(4-methyl-1-pentene) (P4MP1) to a maleated elastomer. Two alternative methods for grafting an amine-terminated poly(4-methyl-1 -pentene) to a maleated elastomer can be evaluated:

A. Preparation via melt-grafting of the functionalized branched olefin copolymer: Polymer pellets of maleic anhydride grafted poly(ethylene-co-butene) random copolymer (EBR-g-MAH; T_{g}: −64° C.; content of ethylene: 80 mol percent; content of maleic anhydride: 1.0 wt percent; Mw: 250,000 PS standard) (29.3 g) is melted at 260° C. with 3000 part per million (ppm) by weight of Irganoxm 225 (available from Ciba Specialty Chemicals Basel, Switzerland) using a Haake Polylab/Rheocord mixer (model 557-9301, Thermo Electron, Newington, N.H.) equipped with a small Rheomix bowl (69 cc) at 40 RPM. The amine-terminated poly(4-methyl-1-pentene) (15.8 g) previously prepared according to this Example is then added to the Haake Rheocord mixer. The melt mixture is allowed to react and the graft reaction is monitored by measuring the torque. The reaction is allowed for an additional 10 minutes after the amine-terminated poly(4-methyl-1-pentene) melted. A total of 45 grams of polymer blend is obtained. The resultant blend is removed from the Haake and cooled to room temperature.

Properties of the melt-grafted olefin copolymer:

| | Tensile | Elongation @ | Elastic | |
|---|---|---|---|---|
| | Strength, | Break, | Recovery, | TMA, |
| Sample | MPa | percent | percent | ° C. |
| 65/35 Blend* | 1.50 | 211 | 87 | 96 |
| Graft Copolymer** | 5.85 | 504 | 86 | 162 |

*The blend is defined here as the melt blend of EBR-g-MAH with vinyl-terminated PP.
**Graft copolymer is the graft product obtained via the melt-grafting method.

B. Preparation via solution-grafting of the functionalized branched olefin copolymer: Into a dry, 3-neck, 2000 mL round bottom flask is loaded amine-terminated poly(4-methyl-1-pentene) (12.25 g), EBR-g-MAH (as described above, 22.75 g)) and 1,4-diazabicyclo[2,2,2] octane (0.04 g, FW 112.18, Available form Aldrich). The flask is placed under a slow N₂ purge via a glass inlet adaptor and exiting via an outlet adaptor through a mineral oil bubbler. The apparatus is completed with a glass stir-shaft with glass blade, stir-bearing, stir-motor, Dean-Stark trap and condenser. Xylene (870 mL) is added to the flask and the mixture is heated to reflux with a heating-mantle. Mixture remains at a slow reflux for 8 hours. Solution is cooled slightly and product is precipitated into ˜2.5 L of methanol containing Irganox™ 1010 (˜0.5 g available from Ciba Specialty Chemicals) as a soft, opaque solid. Precipitated polymer is collected and washed with fresh methanol (˜1.5 L) containing Irganox™ 1010 (0.1 g). Polymer is collected and dried to constant weight in a 75° C. vacuum oven overnight.

Properties of the solution-grafted olefin copolymer:

| | Tensile | Elongation @ | Elastic | |
|---|---|---|---|---|
| | Strength, | Break, | Recovery, | TMA, |
| Sample | MPa | percent | percent | ° C. |
| 65/35 Blend* | 2.84 | 1310 | 82 | 103.7 |
| Graft Copolymer** | 14.9 | 800 | 81 | 172.2 |

*The blend is defined here as the blend of EBR-g-MAH with vinyl-terminated PP subjected to dissolution and similar heat history as the graft copolymer.
**Graft copolymer is the graft product described obtained via the solution grafting method.

1. An olefinic composition comprising a functionalized branched olefin copolymer containing functionalized sidechains derived from olefin and at least one chain end nucleophilic heteroatom containing functional group with at least one protic hydrogen, optionally with one or more copolymerizable monomers, the copolymer having A) a T_{g}<−10° C. as measured by DSC; B) a Tₘ>100° C.; C) an elongation at break of greater than or equal to 500 percent; D) a Tensile Strength of greater than or equal to 1,500 psi (10,300 kPa) at 25° C.; E) a TMA temperature>80° C., and F) an elastic recovery of greater than or equal to 50 percent.

2. The composition of claim 1 wherein the functional group is selected from the group consisting of primary or secondary amines, alcohols, thiols, aldehydes, carboxylic acids, and sulfonic acids.

3. The composition of claim 2 wherein the amines correspond to the formula P-N-RX HM, wherein P is the polymer side chain derived from olefin, N is nitrogen, R is C₁-C₂₀ hydrocarbyl, H is hydrogen, M is 1 or 2 and X is (2−M).

4. The olefinic composition of claim 1 where the T_{g} of the functionalized sidechains is less than −30° C., and the Tₘ of the sidechains is greater than or equal to 100° C.

5. The composition of claim 1 wherein said functionalized branched olefin copolymer comprises functionalized sidechains derived from propylene and at least one chain end primary amine functional group, optionally with one or more copolymerizable monomers.

6. The composition of claim I wherein said functionalized branched olefin copolymer comprises functionalized sidechains derived from 4-methyl-1-pentene and at least one chain end primary amine functional group, optionally with one or more copolymerizable monomers.

7. A process of making a functionalized branched olefin copolymer comprising reacting a maleated elastomer with an amine terminated olefin polymer.

8. A process of making a functionalized branched olefin copolymer comprising reacting a maleated elastomer with an olefinic polymer containing a chain end heteroatom containing functional group with at least one protic hydrogen.

9. The process of claims 7 or 8, wherein the reacting step is performed in an extruder.

10. The process of claims 7 or 8, wherein the reacting step is performed in solution.

11. The composition of claim 1 wherein said functionalized branched olefin copolymer comprises a functionalized ethylene/alpha-olefin copolymer having a density of less than about 0.89 g/cc, wherein the functionality is capable of reacting with a primary amine.

12. The composition of claim 1 wherein said functionalized branched olefin copolymer comprises a functionalized propylene/alpha-olefin copolymer having a density of less than about 0.87 g/cc, wherein the functionality is capable of reacting with a primary amine.

13. The composition of claim 1 wherein the functionalized copolymer is formed from components comprising an unsaturated organic compound containing at least one olefinic unsaturation and at least one carboxyl group or at least one derivative of the carboxyl group selected from the group consisting of an ester, an anhydride and a salt.

14. The composition of claim 13 wherein the unsaturated organic compound is selected from the group consisting of maleic, acrylic, methacrylic, itaconic, crotonic, alpha-methyl crotonic and cinnamic acids, anhydrides, esters and their metal salts and fumaric acid and its ester and its metal salt.

15. A thermoplastic elastomer composition derived from at least two functionalized olefin copolymers, each copolymer derived from olefins capable of insertion polymerization and each copolymer having a Tm difference of at least 40° C., the composition having A) a T_{g}<−10° C. as measured by DSC; B) a Tₘ>10 C.; C) an elongation at break of greater than or equal to 500 percent; D) a Tensile Strength of greater than or equal to 1,500 psi (10,300 kPa) at 25° C.; E) a TMA temperature >80° C., and F) an elastic recovery of greater than or equal to 50 percent, wherein at least one functionalized copolymer is chain end functionalized with at least one chain end nucleophilic heteroatom containing functional group with at least one protic hydrogen.

16 The composition of claim 15 wherein the at least one chain end nucleophilic heteroatom containing functional group with at least one protic hydrogen is an amine. (primary or secondary).

17. A thermoplastic elastomer composition derived from at least two functionalized olefin copolymers, each copolymer derived from olefins capable of insertion polymerization and each copolymer having a T_{g} difference of at least 40° C., the composition having A) at least one T_{g}<−10° C. as measured by DSC; B) an elongation at break of greater than or equal to 500 percent; C) a Tensile Strength of greater than or equal to 1,500 psi (10,300 kPa) at 25° C.; D) a TMA temperature>80° C., and E) an elastic recovery of greater than or equal to 50 percent, wherein at least one functionalized copolymer is chain end functionalized with at least one chain end nucleophilic heteroatom containing functional group with at least one protic hydrogen.

18. The composition of claims 15 or 17, wherein the composition has an additional T_{g} of greater than about 80° C.

19. The composition of claims 15 or 17, wherein the two functionalized olefin copolymers are selected from the group consisting of maleated elastomer and amine terminated olefin polymers.

20. The composition of claims 15 or 17, wherein one of the functionalized olefin copolymers is selected from the group consisting of maleated elastomers, and one functionalized olefin copolymer is selected from amine terminated olefin polymers.

21. An olefin composition comprising a functionalized branched olefin copolymer containing functionalized sidechains derived from ethylene and at least one chain end nucleophilic heteroatom containing functional group with at least one protic hydrogen, optionally with one or more copolymerizable monomers, the copolymer having A) at least one T_{g}<−10° C. as measured by DSC, B) an elongation at break of greater than or equal to 500 percent; C) a Tensile Strength of greater than or equal to 1,500, psi (10,300 kPa) at 25° C.; D) a TMA temperature >80° C., and E) an elastic recovery of greater than or equal to 50 percent.

22. The composition of claim 21, wherein the copolymer further comprises an additional T_{g} of greater than about 80° C.

23. An olefin composition comprising a functionalized branched olefin copolymer containing functionalized sidechains derived from propylene and at least one chain end nucleophilic heteroatom containing functional group with at least one protic hydrogen, optionally with one or more copolymerizable monomers, the copolymer having A) at least one T_{g}<−10° C. as measured by DSC, B) an elongation at break of greater than or equal to 500 percent; C) a Tensile Strength of greater than or equal to 1,500, psi (10,300 kPa) at 25° C.; D) a TMA temperature >80° C., and E) an elastic recovery of greater than or equal to 50 percent.

24. An olefin composition comprising a functionalized branched olefin copolymer containing functionalized sidechains derived from 4-methyl-1-pentene and at least one chain end nucleophilic heteroatom containing functional group with at least one protic hydrogen, optionally with one or more copolymerizable monomers, the copolymer having A) at least one T_{g}<−10° C. as measured by DSC, B) an elongation at break of greater than or equal to 500 percent; C) a Tensile Strength of greater than or equal to 1,500, psi (10,300 kPa) at 25° C.; D) a TMA temperature>80° C., and E) an elastic recovery of greater than or equal to 50 percent.

25. The composition of claims 15, 17, 21, 23 or 24 wherein the functional group is selected from the group consisting of primary or secondary amines, alcohols, thiols, aldehydes, carboxylic acids, and sulfonic acids.
